(19) United States
(12) Patent Application Publication
(10) Pub. No.: US 2026/0024353 A1
(43) Pub. Date: Jan. 22, 2026

(54) DRIVER-ASSISTANCE APPARATUS, DRIVER-ASSISTANCE METHOD, AND STORAGE MEDIUM

(71) Applicant: HONDA MOTOR CO., LTD., Tokyo (JP)

(72) Inventors: Srinivasa Divakar BHAT, Wako-shi (JP); Prateek GARG, Wako-shi (JP); Akira KANEHARA, Wako-shi (JP); Masamitsu TSUCHIYA, Wako-shi (JP); Ryuji IWASHITA, Wako-shi (JP); Mudit SONI, Wako-shi (JP); Tarun SATHESH, Wako-shi (JP); Surbhi AGRAWAL, Wako-shi (JP)

(21) Appl. No.: 19/340,789

(22) Filed: Sep. 25, 2025

Related U.S. Application Data
(63) Continuation of application No. PCT/JP2023/013625, filed on Mar. 31, 2023.

(51) Int. Cl. G06V 20/58; G06V 10/75; G06V 10/82; G06V 40/16; G08G 1/0962

(52) U.S. Cl. CPC G06V 20/58; G06V 10/751; G06V 40/172; G08G 1/0962; G06V 10/82

(57) ABSTRACT

A driver-assistance apparatus to be attached to a moving body captures an image including an interior of the moving body and a subject outside the moving body, recognizes, by using the captured image, a person in the image, and estimates one or more characteristics of the recognized person in the image. The apparatus detects, as a passerby, the person in the image having each of the one or more estimated characteristics satisfying a predetermined criterion; and causes an output device to output a warning about a presence of the detected passerby. The one or more characteristics include at least one of a distance from the driver-assistance apparatus to the person, a relative moving speed of the person with respect to the moving body, and a height of the person.

### CROSS-REFERENCE TO RELATED APPLICATION(S)

This application is a continuation of International Patent Application No. PCT/JP2023/013625 filed on Mar. 31, 2023, the entire disclosure of which is incorporated herein by reference.

### TECHNICAL FIELD

The present invention relates to a driver-assistance apparatus, a driver-assistance method, and a storage medium.

### BACKGROUND ART

In recent years, a driver-assistance technology has been proposed in which a video of the periphery of a self-vehicle (also referred to as a moving body) captured by a camera installed inside the vehicle is analyzed, and when it is determined that an object in the video is an object requiring attention, a call attention image is displayed at a predicted position of the object requiring attention on a display device (Patent Literature 1). If the driver is warned about attention-requiring objects as they appear by the driver-assistance technology, the driver can pay attention to a highly dangerous object and appropriately avoid danger.

### CITATION LIST

### Patent Literature

PTL1: International Publication No. 2019/159344

### SUMMARY OF INVENTION

### Technical Problem

Incidentally, in some cases, it may be desirable to provide a driver with warnings about passersby passing on the side or rear of a self-vehicle via a dashcam installed inside the vehicle. In many cases, it is necessary to detect passersby around the vehicle by using images captured by a camera disposed so as to include the interior of the vehicle in an imaging range. In such a case, it is necessary to reduce erroneous detection such as detection of a person in the interior of the vehicle as a passerby, and to accurately detect a passerby outside the vehicle from captured images.

The present invention has been made in view of the above problem, and an object of the present invention is to achieve a technology capable of accurately detecting a passerby outside a vehicle in a case of using a captured image including an interior and outside of the vehicle.

### Solution to Problem

According to the present invention, a driver-assistance apparatus to be attached to a moving body is provided, the driver-assistance apparatus comprising: one or more processors; and a memory storing instructions which, when the instructions are executed by the one or more processors, cause the driver-assistance apparatus to: capture an image including an interior of the moving body and a subject outside the moving body; recognize, by using the captured image, a person in the image; estimate one or more characteristics of the recognized person in the image; detect, as a passerby, the person in the image having each of the one or more estimated characteristics satisfying a predetermined criterion; and cause an output device to output a warning about a presence of the detected passerby, wherein the one or more characteristics include at least one of a distance from the driver-assistance apparatus to the person, a relative moving speed of the person with respect to the moving body, and a height of the person.

### Advantageous Effects of Invention

According to the present invention, it is possible to accurately detect a passerby outside a vehicle in a case of using a captured image including an interior and outside of the vehicle.

Other features and advantages of the present invention will be apparent from the following description taken in conjunction with the accompanying drawings. Note that the same reference numerals denote the same or like components throughout the accompanying drawings.

### BRIEF DESCRIPTION OF DRAWINGS

The accompanying drawings, which are incorporated in and constitute a part of the specification, illustrate embodiments of the invention and, together with the description, serve to explain principles of the invention.

FIG. 1 is a diagram schematically illustrating an example of a configuration of a moving body (vehicle) according to an embodiment.

FIG. 2A is a diagram schematically illustrating an external configuration example of a dashcam as an example of a driver-assistance apparatus according to the embodiment.

FIG. 2B is a diagram schematically illustrating an external configuration of an output device according to the embodiment.

FIG. 3 is a block diagram illustrating a hardware configuration example of the dashcam according to the embodiment.

FIG. 4 is a block diagram illustrating a functional configuration example of the dashcam according to the embodiment.

FIG. 5 is a diagram for explaining a characteristic of a person (relative moving speed) according to the embodiment.

FIG. 6 is a diagram for explaining a characteristic of a person (distance from the dashcam) according to the embodiment.

FIG. 7 is a flowchart illustrating a series of operations of driver-assistance processing according to the embodiment.

### DESCRIPTION OF EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

The present embodiment describes, as an example, a case where a driver-assistance apparatus is a dashcam that is attached inside a vehicle, captures images of the front, side, and rear of the vehicle, and records the traveling state of the vehicle on a recording medium. However, the driver-assistance apparatus may be a device other than a dashcam as long as the driver-assistance apparatus is attached to a vehicle and can capture an image of the exterior view seen from the vehicle. Furthermore, the following embodiment will be described based on an example where the moving body is, for example, a vehicle. The vehicle is typically a four-wheeled vehicle, but the present embodiment may be applied to other types of vehicles.

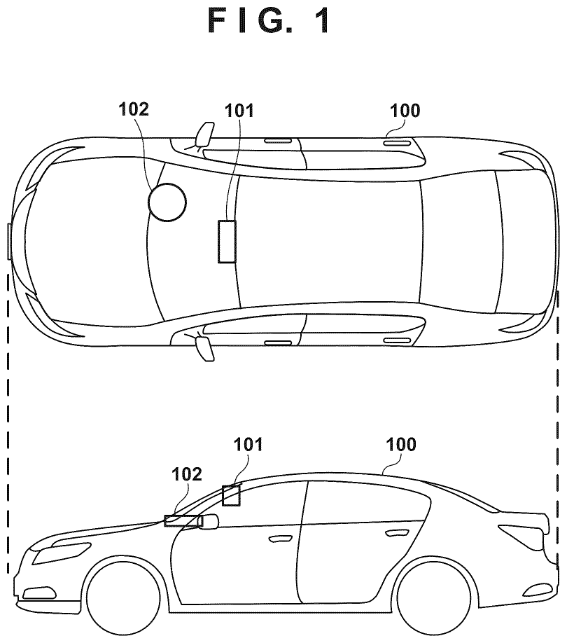

An example of a position where the dashcam is attached will be described with reference to FIG. 1. A dashcam 101 is attached to a vehicle 100. The dashcam 101 is attached to a position that does not obstruct a driver's view, the position being either on a windshield of the vehicle 100 near a rear-view mirror or on the rear-view mirror of the vehicle 100. The attachment position of the dashcam 101 is not limited to such a position, and may be any position as long as an image of the exterior view seen from the vehicle 100 can be captured.

For example, the dashcam 101 can transmit information required to be output to the driver to an external output device 102 wirelessly or by wire, and cause the output device 102 to output the transmitted warning. Note that in the description of the present embodiment, a case where the output device 102 is an external device of the dashcam 101 will be described as an example. However, the dashcam 101 may include an output device (that is, a display for displaying or a speaker for outputting audio).

### <External Configuration Example of Dashcam>

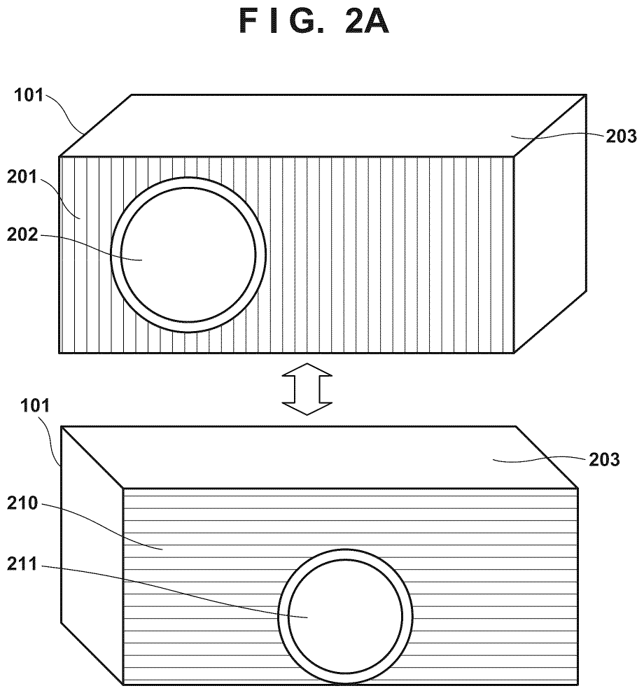

An external configuration example of the dashcam 101 will be described with reference to FIG. 2A. The dashcam 101 includes an image capturing device 202 on a front surface 201, and captures an image of the forward direction (moving direction) of the vehicle 100. The image capturing device 202 is, for example, an image capturing device including a wide-angle lens. In addition, the dashcam 101 includes an image capturing device 211 on a back surface 210, and captures images of the side and the rear of the vehicle 100. The image capturing device 211 is, for example, an image capturing device including a fisheye lens. The image captured by the image capturing device 211 includes the driver of the vehicle 100. Reference numeral 203 represents an upper surface of the dashcam 101.

### <External Configuration Example of Output Device>

An external configuration example of the output device 102 will be described with reference to FIG. 2B. The output device 102 is a device for outputting information to an occupant of the vehicle 100. The output device 102 includes a display device (for example, a display or a light emitting element) that provides visual information, and a sound device (for example, a speaker) that provides auditory information. The output device 102 communicates with the dashcam 101 wirelessly or by wire to display information on the display device.

The output device 102 includes the display device on its upper surface 220. The output device 102 can color display a partial region (for example, 222) in a circle 221 representing the periphery of the vehicle 100 in response to an instruction from the dashcam 101. The colored region 222 serves as a warning output to the driver or the like that a risk is present in the corresponding direction. The output device 102 is installed, for example, on a dashboard near the driver's seat of the vehicle 100. The output device 102 may further include a half mirror to reflect light output from the upper surface 220 toward the driver.

### <Hardware Configuration Example of Dashcam>

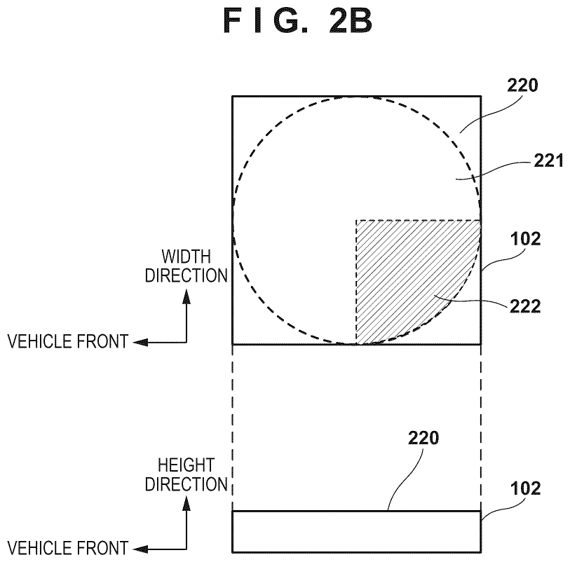

A hardware configuration example of the dashcam 101 will be described with reference to FIG. 3. The dashcam 101 includes, for example, a control unit 301, a storage device 302, an image capturing device 303, an input device 304, and a communication device 305.

The control unit 301 includes, for example, a processor such as a central processing unit (CPU) and controls the overall operation of the dashcam 101. The control unit 301 may be implemented by, for example, the CPU loading and executing a program stored in the storage device 302. The control unit 301 may further include, in addition to the CPU, a graphics processing unit (GPU) and a circuit designed specifically for image processing, machine learning, or the like.

The storage device 302 is a device that stores data and a program related to the operation of the dashcam 101. For example, the storage device 302 may store a program that defines the operation of the dashcam 101, temporary data used during the execution of the program, an image captured by the image capturing device 303, an ambient sound picked up by a microphone, and the like. The storage device 302 may be implemented by a memory such as a random access memory (RAM) or a read only memory (ROM). The storage device 302 may further include a secondary storage device such as a solid state drive (SSD).

The image capturing device 303 includes a camera for capturing an image of a front exterior view seen from the vehicle 100. The image capturing device 303 may be, for example, a wide-angle camera. This camera is the above-described image capturing device 202 located on the front side of the dashcam 101 (the front side of the vehicle 100). Furthermore, the image capturing device 303 includes a camera capable of capturing images of the rear, and left and right sides of the vehicle 100, that is, the above-described image capturing device 211. This camera may be a camera including a fisheye lens. The camera that captures an image of the rear is disposed on the rear side of the dashcam (the rear side of the vehicle). In the present embodiment, a case where images of the rear and the sides of the vehicle are captured by the same camera will be described as an example. However, the camera that captures an image of the rear and the camera that captures images of the sides may be separate cameras. The side-image capturing camera may be disposed on a side surface of the dashcam. Some of the cameras that capture images of views in a plurality of directions may be provided separately from the dashcam.

The input device 304 is a device for receiving an instruction from the occupant of the vehicle 100. The input device 304 includes, for example, a button or a touchscreen. Moreover, the input device 304 may include a microphone that receives a voice of the occupant or an ambient sound.

The communication device 305 is a device that allows the dashcam 101 to communicate with the output device 102 by wire or wirelessly. The communication device 305 transmits warning information generated through driver-assistance processing performed by the control unit 301 to the output device 102. The communication device 305 may communicate with another device by wire or wirelessly. Wireless communication may be communication compliant with a protocol for short-range communication (for example, Bluetooth (registered trademark)) or the like. The communication device 305 may be capable of communicating with a control ECU of the vehicle 100 by wire or wirelessly. The communication device 305 may be optional.

### <Functional Configuration Example of Dashcam>

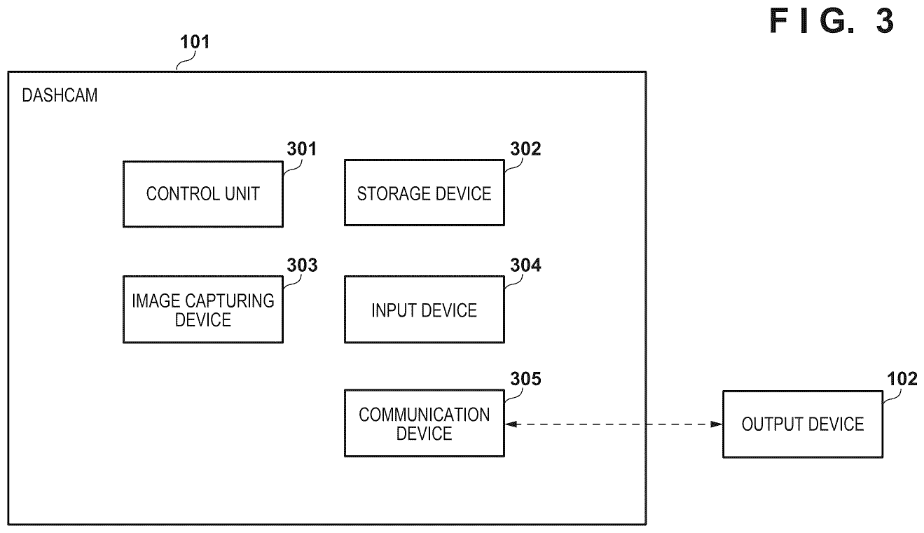

A functional configuration example implemented by the control unit 301 of the dashcam 101 will be described with reference to FIG. 4. Each unit illustrated in FIG. 4 is implemented by, for example, the CPU of the control unit 301 executing a computer program.

An image acquisition unit 401 acquires a front captured image from the image capturing device 202 that captures an image of the front of the dashcam 101. Furthermore, the image acquisition unit 401 acquires a rear captured image from the image capturing device 211 that captures an image of the rear side of the dashcam 101. The rear captured image includes a subject outside the vehicle and the interior of the vehicle in the image. For example, the rear captured image includes a passerby walking outside the vehicle 100 and the occupant present in the interior of the vehicle.

A person recognition unit 402 recognizes a person included in the image (rear captured image) acquired by the image acquisition unit 401. The person recognition unit 402 may use a neural network that inputs the rear captured image and outputs a recognition result of the person. In a case where at least a part of a person's body is included in the image, the person recognition unit 402 may be capable of recognizing the part as a person.

A characteristic estimation unit 403 estimates one or more characteristics of the person in the image recognized by the person recognition unit 402. The one or more characteristics include, for example, at least one of a distance from the dashcam 101 to the person, a relative moving speed of the person with respect to the vehicle 100, and a height of the person. The characteristics of the person will be described later.

A passerby detection unit 404 determines whether one or more characteristics of the person estimated by the characteristic estimation unit 403 satisfy predetermined criteria, and detects a person who satisfies all of the criteria as a passerby. The criteria to be satisfied by the characteristics will be described later.

An output control unit 405 causes the output device 102 to output a warning when the detected passerby approaches a position within a predetermined range from the traveling track of the vehicle 100. For example, the control unit 301 estimates a predicted track of the detected passerby, and if a warning is necessary, causes the output device 102 to output a warning indicating a direction in which the passerby is present.

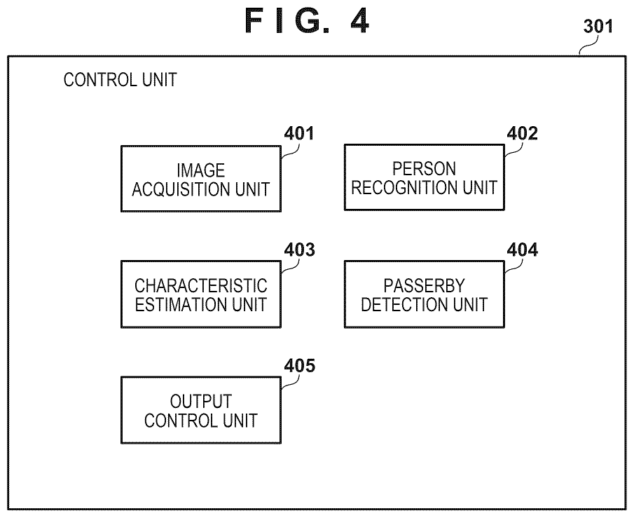

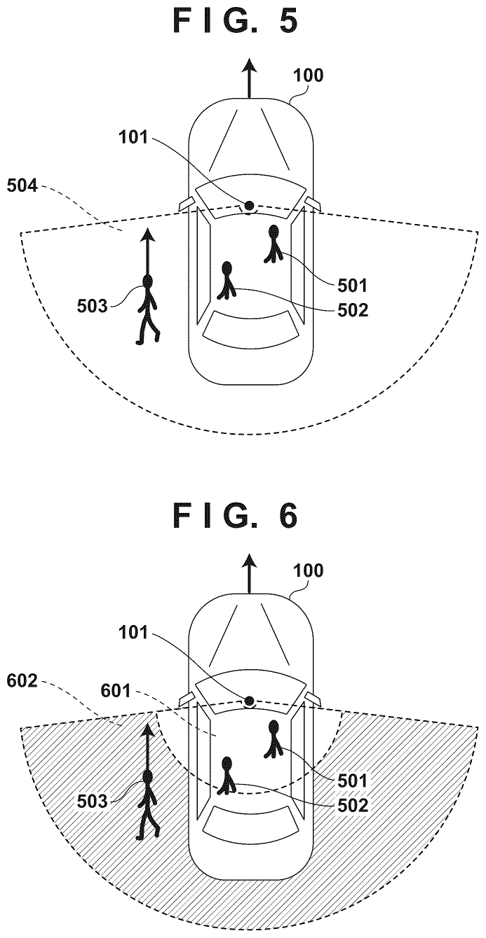

Next, characteristics of a person and criteria to be satisfied by the characteristics according to the present embodiment will be described with reference to FIGS. 5 and 6.

FIG. 5 illustrates a specific example in a case where a characteristic of a person is a relative moving speed of the person with respect to the vehicle 100. For example, it is assumed that persons 501 and 502 are on the vehicle 100, and a person 503 is passing by outside the vehicle. The characteristic estimation unit 403 can estimate a predicted track and moving speed of the vehicle according to changes in (time series of) front captured images or the (time series of) rear captured images. In addition, the characteristic estimation unit 403 can estimate a moving speed of each of the person 501, the person 502, and the person 503 by using the (time-series of) rear captured images. For example, the characteristic estimation unit 403 estimates an absolute value of the relative moving speed of each of the person 501 and the person 502 with respect to the vehicle 100 based on changes in the region of each person or the predicted track of each person. In addition, the characteristic estimation unit 403 estimates an absolute value of the relative moving speed of the person 503 with respect to the vehicle 100 based on changes in the region of the person 503 or the predicted track of the person 503. Note that the moving speed of a person is not limited to the above-described method, and may be estimated by a known method, for example, by inputting a rear captured image to a neural network.

When the absolute value of the relative moving speed of a person with respect to the vehicle 100 is greater than a predetermined threshold, the passerby detection unit 404 determines that the person in the image satisfies a criterion of the relative moving speed of the person with respect to the vehicle 100. For example, the absolute values of the relative moving speeds of the person 501 and the person 502 with respect to the vehicle 100 are generally small (that is, smaller than the threshold). In this case, for example, the passerby detection unit 404 determines that the person 501 and the person 502 do not satisfy the criterion of the relative moving speed, and does not detect the person 501 and the person 502 as passersby. On the other hand, when the absolute value of the relative moving speed of the person 503 with respect to the vehicle 100 exceeds the threshold, the passerby detection unit 404 determines that the person 503 satisfies the criterion of the relative moving speed and detects the person as a passerby. In this manner, it is possible to exclude a person having a moving speed that is not appropriate as a passerby from a processing target by considering the relative moving speed of the person, thereby accurately detecting a passerby outside the vehicle.

FIG. 6 illustrates a specific example in a case where a characteristic of a person is a distance from the dashcam 101 to the person. Similarly to the case in FIG. 5, for example, it is assumed that persons 501 and 502 are on the vehicle 100, and the person 503 is passing by outside the vehicle.

The characteristic estimation unit 403 estimates the distances from the dashcam 101 to the person 501, the person 502, and the person 503 using (time-series of) rear captured images. The distance from the dashcam 101 to a person may be estimated by a known method, for example, by inputting rear captured images to a neural network.

When the distances from the dashcam 101 to the persons 501 and 502 are equal to or less than a threshold corresponding to the interior of the vehicle 100 (for example, a threshold indicating a range 601), the passerby detection unit 404 determines that the persons 501 and 502 do not satisfy a criterion of the distance. Therefore, the persons 501 and 502 are not detected as passersby.

On the other hand, when the distance from the dashcam 101 to the person 503 is greater than the threshold corresponding to the interior of the vehicle 100 and equal to or less than a threshold defining a farther distance (for example, a threshold indicating a range 602), the passerby detection unit 404 determines that the person 503 satisfies the criterion of the distance from the dashcam to the person. Therefore, the person 503 is detected as a passerby. In this manner, it is possible to exclude a person located at a distance that is not appropriate as a passerby from a processing target by considering the distance from the dashcam 101, thereby accurately detecting a passerby outside the vehicle.

A characteristic of a person may be the height of the person. In general, the size of a person's face has a small individual difference, which is a useful parameter to detect a person from an image. However, when the person is far away from the image capturing device, the size of the face in the image is very small. Therefore, in the present embodiment, the height of a person is used as the characteristic of the person in order to perform effective evaluation using image information even when the person is far away from the image capturing device. However, the size of a person's face may be used as a further characteristic of the person.

The characteristic estimation unit 403 estimates the height of the person based on the size of the person's region in the image. The height of the person may be estimated by a known method, for example, by inputting rear captured images to a neural network.

When the height of the person is within a range determined according to the distance from the dashcam 101 to the person, the passerby detection unit 404 determines that the person satisfies a criterion of the height. Note that, in a case where a characteristic of a person such as the height is estimated from a captured image, the estimation error tends to increase as the distance to the person increases. Therefore, in the present embodiment, an allowable error range of the estimated height is determined in advance for each distance from the dashcam 101. With this allowable error range, in the present embodiment, when the estimated height exceeds the allowable error range, the person is not detected as a passerby. In this manner, it is possible to exclude a person having a height in an inappropriate range as a passerby from a processing target by considering the height of the person, thereby accurately detecting a passerby outside the vehicle.

### <Series of Operations of Driver-Assistance Processing in Dashcam>

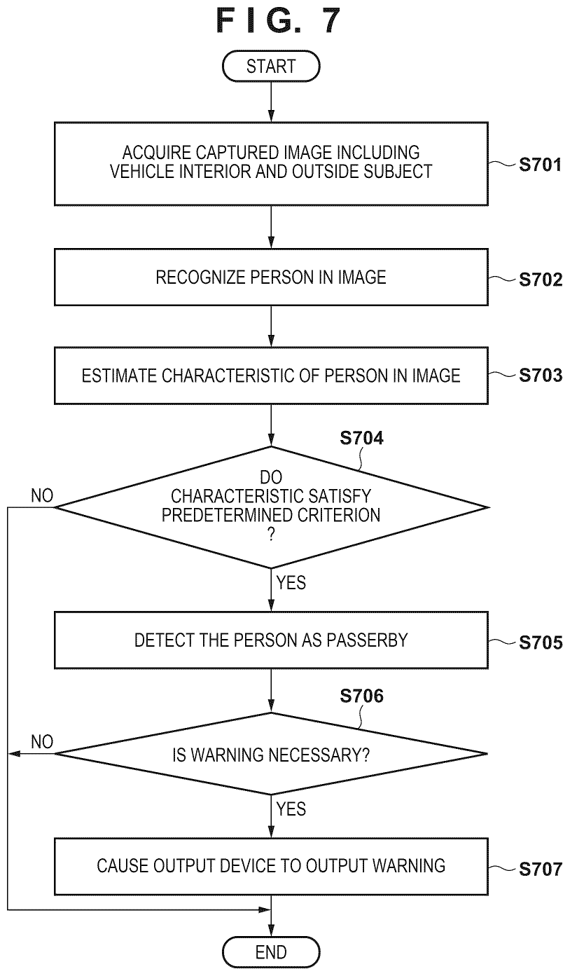

Next, a series of operations of the driver-assistance processing to be executed in the dashcam 101 will be described with reference to FIG. 7. Note that this processing is implemented by the CPU of the control unit 301 executing a computer program stored in the storage device 302.

Note that, in the following description, a case where a person in an image satisfying a predetermined criterion is detected as a passerby is described as an example of processing for detecting a passerby. However, the processing for detecting a passerby may include any other detection processing. In the present embodiment, erroneous detection of a passerby can be reduced by not detecting a person whose characteristic does not satisfy a predetermined criterion among persons in an image as a passerby, and as a result, it is possible to accurately detect a passerby outside the vehicle.

In S701, the image acquisition unit 401 acquires a rear captured image obtained by capturing an image of the rear of the dashcam 101. The rear captured image includes a subject outside the vehicle and the interior of the vehicle in the image. In S702, the person recognition unit 402 recognizes a person in the image. In S703, the characteristic estimation unit 403 estimates one or more characteristics of the person in the image. As described above, the characteristics of the person include, for example, at least one of the distance from the dashcam 101 to the person, the relative moving speed of the person with respect to the vehicle 100, and the height of the person.

In S704, the passerby detection unit 404 determines whether the estimated characteristic satisfies a predetermined criterion. Specifically, as described with reference to FIGS. 4, 5, and 6, the passerby detection unit 404 determines whether the estimated characteristic, such as the height of the person or the like, satisfies the predetermined criterion. When the passerby detection unit 404 determines that the characteristic of the passerby satisfies the predetermined criterion (in a case of a plurality of characteristics, all the criteria are satisfied), the processing proceeds to S705. Otherwise, the series of processing is terminated. In S705, the passerby detection unit 404 detects a person to be processed as a passerby. For example, in the examples in FIGS. 5 and 6 described above, the person 503 is detected as a passerby.

In S706, the output control unit 405 determines whether it is necessary to output a warning about the detected passerby to the driver. For example, when the detected passerby approaches a position within a predetermined range from the traveling track of the vehicle 100, the output control unit 405 determines that it is necessary to output a warning. When the output control unit 405 determines that it is necessary to output a warning, the processing proceeds to S707. Otherwise, the series of processing is terminated.

In S707, the output control unit 405 causes the output device 102 to output a warning indicating a direction in which the passerby is present (for example, the region 222 in FIG. 2B). The output control unit 405 causes the output device 102 to output a warning indicating the direction in which the passerby is present based on, for example, the track already obtained for the detected passerby.

Note that, in the above-described embodiment, in order to detect a passerby present around the vehicle, it is determined whether the characteristics of a person satisfy the criteria. The control unit 301 may perform the processing for excluding a registered occupant from a processing target before the characteristic estimation unit 403 performs the processing for estimating the characteristics of the person. For example, the control unit 301 registers the face of the occupant in the dashcam 101 in advance (by a user operation or the like). Then, the control unit 301 may identify, for example, a person having a face feature matching the face feature registered in advance among recognized persons in an image. The characteristic estimation unit 403 is only required to estimate one or more characteristics of a person other than the identified person. With this processing, it is possible to omit unnecessary estimation processing for the occupant, thereby increasing processing speed and saving power.

In addition, in the above-described embodiment, the case where a warning is output by the output device 102 has been described as an example, but a warning may be output by at least one of a smartphone, a tablet terminal, a head-mounted display, and a wearable terminal. These devices communicate with the dashcam 101 wirelessly or by wire to display a warning on the display device.

### SUMMARY OF EMBODIMENTS

1. A driver-assistance apparatus (for example, 101) of the above embodiment includes a driver-assistance apparatus to be attached to a moving body (for example, 100), the driver-assistance apparatus characterized by comprising:
imaging means (for example, 401) for capturing an image including an interior of the moving body and a subject outside the moving body;
recognition means (for example, 402) for recognizing, by using the captured image, a person in the image;
estimation means (for example, 403) for estimating one or more characteristics of the recognized person in the image;
detection means (for example, 404) for detecting, as a passerby, the person in the image having each of the one or more estimated characteristics satisfying a predetermined criterion; and
output control means (for example, 405) for causing an output device to output a warning about a presence of the detected passerby, wherein
the one or more characteristics include at least one of a distance from the driver-assistance apparatus to the person, a relative moving speed of the person with respect to the moving body, and a height of the person.

According to this embodiment, it is possible to accurately detect a passerby outside a vehicle in a case of using a captured image including an interior and outside of the vehicle.
2. In the driver-assistance apparatus of the above embodiment, the detection means determines, when the distance from the driver-assistance apparatus to the person in the image is greater than a threshold corresponding to the interior of the moving body and equal to or less than a threshold defining a farther distance, that the person in the image satisfies a criterion of the distance from the driver-assistance apparatus to the person.

According to this embodiment, it is possible to exclude a person located at a distance that is not appropriate as a passerby from a processing target by considering the distance from the dashcam 101, thereby accurately detecting a passerby outside the vehicle.
3. In the driver-assistance apparatus of the above embodiment, the detection means determines, when an absolute value of the relative moving speed of the person with respect to the moving body is greater than a predetermined threshold, that the person in the image satisfies a criterion of the relative moving speed of the person with respect to the moving body.

According to this embodiment, it is possible to exclude a person having a moving speed that is not appropriate as a passerby from a processing target by considering the relative moving speed of the person, thereby accurately detecting a passerby outside the vehicle.
4. In the driver-assistance apparatus of the above embodiment, the detection means determines, when the height of the person is within a range determined according to the distance from the driver-assistance apparatus to the person, that the person in the image satisfies a criterion of the height of the person.

According to this embodiment, it is possible to exclude a person having a height in an inappropriate range as a passerby from a processing target by considering the height of the person, thereby accurately detecting a passerby outside the vehicle.
5. In the driver-assistance apparatus of the above embodiment, the estimation means estimates one or more characteristics of a person other than a person having a face feature matching a face feature registered in advance among recognized persons in the image.

According to this embodiment, it is possible to omit unnecessary estimation processing for an occupant, thereby increasing processing speed and saving power.
6. In the driver-assistance apparatus of the above embodiment, the output control means causes the output device to output a warning indicating a direction in which the detected passerby is present.

According to this embodiment, it is possible for a driver to quickly and easily grasp where the warning target is around.
7. In the driver-assistance apparatus of the above embodiment, the output device is included in the driver-assistance apparatus.

According to this embodiment, it is possible to perform driver assistance with an easily installable configuration by a single driver-assistance apparatus.
8. In the driver-assistance apparatus of the above embodiment, the output device communicates with the driver-assistance apparatus wirelessly or by wire to display the warning on a display device of the output device.

According to this embodiment, it is possible to dispose the output device at a position easily perceived by the driver.
9. In the driver-assistance apparatus of the above embodiment, the output device is at least one of a smartphone, a tablet terminal, a head-mounted display, and a wearable terminal.

According to this embodiment, it is possible to use a separately used device as the output device, thereby reducing the manufacturing cost of the driver-assistance apparatus.
10. A driver-assistance method of the above embodiment includes a driver-assistance method executed by a driver-assistance apparatus (for example, 101) to be attached to a moving body (for example, 100), the driver-assistance method characterized by comprising:
capturing (for example, S701) an image including an interior of the moving body and a subject outside the moving body;
recognizing (for example, S702), by using the captured image, a person in the image;
estimating (for example, S703) one or more characteristics of the recognized person in the image;
detecting (for example, S704), as a passerby, the person in the image having each of the one or more estimated characteristics satisfying a predetermined criterion; and
causing (for example, S705) an output device to output a warning about a presence of the detected passerby, wherein
the one or more characteristics include at least one of a distance from the driver-assistance apparatus to the person, a relative moving speed of the person with respect to the moving body, and a height of the person.

According to this embodiment, it is possible to accurately detect a passerby outside a vehicle in a case of using a captured image including an interior and outside of the vehicle.
11. A program according to the above embodiment includes a program causing a computer to function as each means of a driver-assistance apparatus (for example, 101) to be attached to a moving body (for example, S100), the driver-assistance apparatus characterized by comprising:
imaging means (for example, 401) for capturing an image including an interior of the moving body and a subject outside the moving body;
recognition means (for example, 402) for recognizing, by using the captured image, a person in the image;
estimation means (for example, 403) for estimating one or more characteristics of the recognized person in the image;
detection means (for example, 404) for detecting, as a passerby, the person in the image having each of the one or more estimated characteristics satisfying a predetermined criterion; and
output control means (for example, 405) for causing an output device to output a warning about a presence of the detected passerby, wherein
the one or more characteristics include at least one of a distance from the driver-assistance apparatus to the person, a relative moving speed of the person with respect to the moving body, and a height of the person.

According to this embodiment, it is possible to accurately detect a passerby outside a vehicle in a case of using a captured image including an interior and outside of the vehicle.
12. A storage medium of the above embodiment includes a storage medium storing a program causing a computer to function as each means of a driver-assistance apparatus (for example, 101) to be attached to a moving body (for example, 100), the driver-assistance apparatus characterized by comprising:
imaging means (for example, 401) for capturing an image including an interior of the moving body and a subject outside the moving body;
recognition means (for example, 402) for recognizing, by using the captured image, a person in the image;
estimation means (for example, 403) for estimating one or more characteristics of the recognized person in the image;
detection means (for example, 404) for detecting, as a passerby, the person in the image having each of the one or more estimated characteristics satisfying a predetermined criterion; and
output control means (for example, 405) for causing an output device to output a warning about a presence of the detected passerby, wherein
the one or more characteristics include at least one of a distance from the driver-assistance apparatus to the person, a relative moving speed of the person with respect to the moving body, and a height of the person.

According to this embodiment, it is possible to accurately detect a passerby outside a vehicle in a case of using a captured image including an interior and outside of the vehicle.

The invention is not limited to the foregoing embodiments, and various variations/changes are possible within the spirit of the invention.

What is claimed is:

1. A driver-assistance apparatus to be attached to a moving body, the driver-assistance apparatus comprising:
one or more processors; and
a memory storing instructions which, when the instructions are executed by the one or more processors, cause the driver-assistance apparatus to:
capture an image including an interior of the moving body and a subject outside the moving body;
recognize, by using the captured image, a person in the image;
estimate one or more characteristics of the recognized person in the image;
detect, as a passerby, the person in the image having each of the one or more estimated characteristics satisfying a predetermined criterion; and
cause an output device to output a warning about a presence of the detected passerby, wherein
the one or more characteristics include at least one of a distance from the driver-assistance apparatus to the person, a relative moving speed of the person with respect to the moving body, and a height of the person.

2. The driver-assistance apparatus according to claim 1, wherein the instructions causing the driver-assistance apparatus to detect the person in the image include instructions causing the driver-assistance apparatus to determine, when the distance from the driver-assistance apparatus to the person in the image is greater than a threshold corresponding to the interior of the moving body and equal to or less than a threshold defining a farther distance, that the person in the image satisfies a criterion of the distance from the driver-assistance apparatus to the person.

3. The driver-assistance apparatus according to claim 1, wherein the instructions causing the driver-assistance apparatus to detect the person in the image include instructions causing the driver-assistance apparatus to determine, when an absolute value of the relative moving speed of the person with respect to the moving body is greater than a predetermined threshold, that the person in the image satisfies a criterion of the relative moving speed of the person with respect to the moving body.

4. The driver-assistance apparatus according to claim 1, wherein the instructions causing the driver-assistance apparatus to detect the person in the image include instructions causing the driver-assistance apparatus to determine, when the height of the person is within a range determined according to the distance from the driver-assistance apparatus to the person, that the person in the image satisfies a criterion of the height of the person.

5. The driver-assistance apparatus according to claim 1, wherein the instructions causing the driver-assistance apparatus to estimate one or more characteristics of the recognized person include instructions causing the driver-assistance apparatus to estimate one or more characteristics of a person other than a person having a face feature matching a face feature registered in advance among recognized persons in the image.

6. The driver-assistance apparatus according to claim 1, wherein the instructions causing the driver-assistance apparatus to cause the output device to output the warning include instructions causing the driver-assistance apparatus to cause the output device to output a warning indicating a direction in which the detected passerby is present.

7. The driver-assistance apparatus according to claim 1, wherein the output device is included in the driver-assistance apparatus.

8. The driver-assistance apparatus according to claim 1, wherein the output device communicates with the driver-assistance apparatus wirelessly or by wire to display the warning on a display device of the output device.

9. The driver-assistance apparatus according to claim 8, wherein the output device is at least one of a smartphone, a tablet terminal, a head-mounted display, and a wearable terminal.

10. A driver-assistance method executed by a driver-assistance apparatus to be attached to a moving body, the driver-assistance method comprising:
capturing an image including an interior of the moving body and a subject outside the moving body;
recognizing, by using the captured image, a person in the image;
estimating one or more characteristics of the recognized person in the image;
detecting, as a passerby, the person in the image having each of the one or more estimated characteristics satisfying a predetermined criterion; and
causing an output device to output a warning about a presence of the detected passerby, wherein
the one or more characteristics include at least one of a distance from the driver-assistance apparatus to the person, a relative moving speed of the person with respect to the moving body, and a height of the person.

11. A non-transitory computer-readable storage medium storing instructions for executing a driver-assistance method in which each step is executed by a driver-assistance apparatus attached to a moving body, the driver-assistance method comprising:
capturing an image including an interior of the moving body and a subject outside the moving body;
recognizing, by using the captured image, a person in the image;
estimating one or more characteristics of the recognized person in the image;
detecting, as a passerby, the person in the image having each of the one or more estimated characteristics satisfying a predetermined criterion; and
causing an output device to output a warning about a presence of the detected passerby, wherein
the one or more characteristics include at least one of a distance from the driver-assistance apparatus to the person, a relative moving speed of the person with respect to the moving body, and a height of the person.
